(19) United States
(12) Patent Application Publication
(10) Pub. No.: US 2026/0307145 A1
(43) Pub. Date: Oct. 8, 2026

(54) DURABLE METAL-MXENE COMPOSITES AND METHODS OF MAKING THE SAME

(71) Applicants: UCHICAGO ARGONNE, LLC, Chicago, IL (US); UNIVERSITY OF CHICAGO, Chicago, IL (US)

(72) Inventors: Zachary David HOOD, Bolingbrook, IL (US); Shiba ADHIKARI, Naperville, IL (US); Sixbert Picard MUHOZA, Bolingbrook, IL (US); Brian WYATT, JR., Chicago, IL (US)

(73) Assignees: UCHICAGO ARGONNE, LLC, Chicago, IL (US); UNIVERSITY OF CHICAGO, Chicago, IL (US)

(21) Appl. No.: 19/636,726

(22) Filed: Apr. 1, 2026

Related U.S. Application Data
(60) Provisional application No. 63/783,123, filed on Apr. 3, 2025.

(51) Int. Cl. B22F 1/145; B22F 1/05; B22F 1/142; C22C 1/04; C22C 1/059; C22C 21/00; C22C 32/00; H01B 1/22

(52) U.S. Cl. CPC B22F 1/145; B22F 1/05; B22F 1/142; C22C 1/0416; C22C 1/059; C22C 21/00; C22C 32/0047; H01B 1/22; B22F 2301/052; B22F 2304/10; B22F 2998/10; B22F 2999/00

(57) ABSTRACT

A method includes dispersing a first powder, including MXene nanomaterials in a first liquid. The method includes dispersing a second powder, including metal particles, in a second liquid. The method includes mixing the first powder dispersed in the first liquid with the second powder dispersed in the second liquid. The method includes electrostatically adsorbing the MXene nanomaterials onto the metal particles. The method includes collecting a third powder, including the MXene nanomaterials adsorbed onto the metal particles. The method includes drying the third powder. The method includes heating the third powder to form a metal-MXene composite.

### CROSS-REFERENCE TO RELATED APPLICATION

This application claims priority to U.S. Provisional Patent App. No. 63/783,123 filed Apr. 3, 2025, the contents of which is incorporated herein by reference in its entirety.

### STATEMENT OF GOVERNMENT INTEREST

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to MXenes, two-dimensional inorganic compounds.

### BACKGROUND

Metals can be inherently limited in their electrical conductivities and can be susceptible to corrosion in certain environments.

### SUMMARY

Metals such as aluminum and copper have inherent limitations in their electrical conductivities and are susceptible to corrosion to certain environments. The methods and compositions of the present disclosure can address these challenges by providing a scalable process to form metal-MXene composites with enhanced conductivity, strength, and/or corrosion resistance.

One aspect of the present disclosure is directed to a method. The method includes dispersing a first powder in a first liquid. The first powder includes MXene nanomaterials. The method includes dispersing a second powder in a second liquid. The second powder includes metal particles. The method includes mixing the first powder dispersed in the first liquid with the second powder dispersed in the second liquid. The method includes electrostatically adsorbing the MXene nanomaterials onto the metal particles. The method includes collecting a third powder. The third powder includes the MXene nanomaterials adsorbed onto the metal particles. The method includes drying the third powder. The method includes heating the third powder to form a metal-MXene composite.

Another aspect of the present disclosure is directed to a composite material. The composite material includes aluminum. The composite material includes 0.1 wt % to 10 wt % MXene.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 illustrates the synthesis of a metal-MXene composite, according to an example implementation.

FIG. 2 illustrates a schematic flow diagram of a method for forming metal-MXene composites, according to an example implementation.

FIG. 3 illustrates a plot of intensity vs wavenumber, according to an example implementation.

FIG. 4 illustrates an SEM/EDS analysis of metal-MXene composites, according to an example implementation.

FIG. 5 illustrates an XRD analysis of various samples, according to an example implementation.

FIG. 6 illustrates a diagram of a T-cell, according to an example implementation.

FIG. 7 illustrates a plot of electronic conductivities of various samples before sintering, according to an example implementation.

FIG. 8 illustrates a plot of electronic conductivities of various samples after sintering, according to an example implementation.

FIG. 9A illustrates a plot of ζ-potential vs. ethanol-water volume for Al 1100, according to an example implementation. FIG. 9B illustrates a plot of ζ-potential vs. pH for Al 1100, according to an example implementation.

FIG. 10 illustrates SEM images of Al-MXene composites, according to an example implementation.

FIG. 11 illustrates a plot of ζ-potential vs. pH for Cu, according to an example implementation.

FIG. 12 illustrates SEM images of Cu-MXene composites, according to an example implementation.

FIG. 13 illustrates an EDS analysis of Cu-MXene composites, according to an example implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Following below are more detailed descriptions of various concepts related to, and implementations of, methods, apparatuses, and systems for durable metal-MXene composites. The various concepts introduced above and discussed in greater detail below may be implemented in any of a number of ways, as the described concepts are not limited to any particular manner of implementation. Examples of specific implementations and applications are provided primarily for illustrative purposes.

The electrical conductivity of metals, such as aluminum (Al) and copper (Cu), is inherently limited. These metals exhibit susceptibility to corrosion under specific environmental conditions. Existing metal composites have demonstrated an inability to provide the requisite combination of electrical, mechanical, and corrosion-resistant properties needed for targeted applications. Methodologies including high-energy ball milling and sintering have been employed in the creation of metal-matrix composites. Although these techniques have contributed to improvements in mechanical properties, they offer restricted control over the resulting microstructure, leading to variability in both conductivity and corrosion resistance. The limitations of such approaches are further compounded by the non-scalable nature of these techniques, which contribute to the non-uniform dispersion of MXene within the matrix, resulting in agglomeration and inconsistent material properties. Furthermore, other methodologies for metal-MXene composite fabrication have relied on trial-and-error approaches, limiting the precise control needed to optimize the material's structural integrity and performance, specifically in terms of electrical conductivity and corrosion resistance.

The present disclosure is directed to a method for the production of metal-MXene composites, designed to improve electrical conductivity, tensile strength, and corrosion resistance. The solution-based, scalable process ensures uniform integration of MXene into metal matrices, promoting consistent dispersion along grain boundaries while mitigating agglomeration. The uniformity of the metal-MXene composites can be characterized (e.g., assessed) using ultrasound techniques. This controlled microstructural refinement yields significant enhancements in conductivity relative to baseline metals, along with improvements in mechanical strength and corrosion resistance, thereby rendering the material highly suitable for advanced electrical and industrial applications such as electrical wires, power transmission, microelectronics, and aerospace.

The metal-MXene composites of the present disclosure can be fabricated using a scalable, solution-based process. Unlike other metal composites, which suffer from inconsistent properties due to agglomeration and non-uniform dispersion, the metal-MXene composites of the present disclosure demonstrated uniform MXene integration and enhanced structural integrity. The metal-MXene composites of the present disclosure have broad applications where enhanced electrical conductivity, mechanical strength, and/or corrosion resistance are needed.

Examples uses for the metal-MXene composites include defense, aerospace, marine, biomedical, power transmission, electronics, energy storage, and electric vehicles. The metal-MXene composites are especially suited for harsh environments like marine or chemical processing, where corrosion resistance is needed. Furthermore, the metal-MXene composites of the present disclosure offer significant advantages over other materials by improving conductivity, strength, and corrosion resistance. The solution-based process ensures uniform MXene dispersion, eliminating agglomeration issues common in other methods and delivering more consistent performance. Additionally, the process is scalable, making it suitable for large-scale manufacturing. Alternative uses include advanced coatings, wear-resistant surfaces, and heat management systems. The method can also be adapted for different MXene and metal combinations, broadening its applications to sectors such as biomedical devices and renewable energy systems.

MXenes are a class of two-dimensional materials. MXenes are typically transition metal carbides or nitrides. MXenes have a general formula of Mₙ₊₁XₙTₓ (1≤n≤4), where M represents an early transition metal (e.g., M=Ag, Sn, Zn, Ru, Ni, or Fe), X represents carbon and/or nitrogen, Tₓ (or T) represents surface termination groups such as —O, —OH, —F, etc. Tₓ can be present in an amount based on charge balance of the MXene. MXenes are a family of two-dimensional carbides, nitrides, and/or carbonitrides. As illustrated by their general formula, Mₙ₊₁XₙTₓ, MXenes include n+1 layers of early transition metals (M) interleaved with n layers of carbon and/or nitrogen (X) with the outer layers terminated by a variety of surface groups (Tₓ=O, OH, F, etc). MXenes can be produced by selective etching of A layers from the MAX phase. MXenes have high electronic conductivity and corrosion resistance, and are lightweight and high strength materials.

MXene synthesis involves synthesis of MAX and etching to form MXene. The synthesis of MXene precursors includes (1) powder mixing of powder samples such as powder samples of TiC, Ti, and Al, (2) physical mixing and ball milling of the powder samples, and (3) pelletizing the powder samples using a die set and pellet press. The synthesis of MXene precursors further includes inert sintering of the pellets in a furnace (e.g., tube furnace) to synthesize the MXene precursors. The synthesis of MXenes includes (1) crushing the sintered pellets, (2) etching the crushed pellets (e.g., using a mild etching process involving NaF, HCl, and the MXene precursors at 50 °C for 4 days), and (3) washing and drying the MXene powder. The MXene powder can be made of MXene nanomaterial (e.g., MXene sheets, MXene nanosheets, MXene layers, MXene particles, MXene platelets). In one example, the thickness of a single layer of MXene is less than 1 nm.

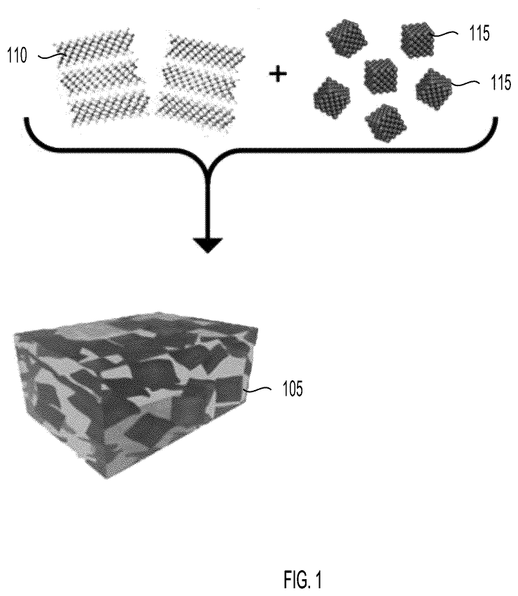

FIG. 1 illustrates the synthesis of a metal-MXene composite 105. The synthesis of the metal-MXene composite 105 includes liquid-phase mixing of MXene (e.g., Ti₃C₂Tₓ) and a metal (e.g., metal particles 115). In some examples, the metal includes Al, Cu, Ag, Au, Ni, Ni alloys, or W. The MXene can include MXene nanomaterials 110. The metal can include metal particles 115. The resulting mixture can be dried, and then sintered or melted to form the metal-MXene composite 105.

The metal-MXene composite 105 can have increased conductivity, improved corrosion resistance, and/or improved mechanical properties relative to the metal without the MXene (e.g., baseline metal, bare metal). For example, the conductivity of the metal-MXene composite 105 is greater than the conductivity of the metal, the corrosion resistance of the metal-MXene composite 105 is greater than the corrosion resistance of the metal alone, and/or the mechanical strength of the metal-MXene composite 105 is greater than the mechanical strength of the metal alone.

In one example, the conductivity of an Al-MXene composite is greater than the conductivity of Al metal, the corrosion resistance of the Al-MXene composite is greater than the corrosion resistance of Al, and/or the mechanical strength of the Al-MXene composite is greater than the mechanical strength of Al metal. In another example, the conductivity of a Cu-MXene composite is greater than the conductivity of Cu metal, the corrosion resistance of the Cu-MXene composite is greater than the corrosion resistance of Cu metal, and/or the mechanical strength of the Cu-MXene composite is greater than the mechanical strength of Cu metal. In another example, the conductivity of a Ag-MXene composite is greater than the conductivity of Ag metal, the corrosion resistance of the Ag-MXene composite is greater than the corrosion resistance of Ag metal, and/or the mechanical strength of the Ag-MXene composite is greater than the mechanical strength of Ag metal. In another example, the conductivity of a Au-MXene composite is greater than the conductivity of Au metal, the corrosion resistance of the Au-MXene composite is greater than the corrosion resistance of Au metal, and/or the mechanical strength of the Au-MXene composite is greater than the mechanical strength of Au metal. In another example, the conductivity of a Ni-MXene composite is greater than the conductivity of Ni metal, the corrosion resistance of the Ni-MXene composite is greater than the corrosion resistance of Ni metal, and/or the mechanical strength of the Ni-MXene composite is greater than the mechanical strength of Ni metal. In another example, the conductivity of a W-MXene composite is greater than the conductivity of W metal, the corrosion resistance of the W-MXene composite is greater than the corrosion resistance of W metal, and/or the mechanical strength of the W-MXene composite is greater than the mechanical strength of W metal.

The metal-MXene composite 105 is a composite material. The composition of the metal-MXene composite 105 can be made primarily of metal with a small fraction of MXene. The composite material can be made of metal and MXene. For example, the composite material can include a metal (e.g., 90 wt % metal to 99.9 wt % metal) and 0.1 wt % to 10 wt % MXene. The composite material can include 97 wt % metal to 99.9 wt % metal and 0.1 wt % to 3 wt % MXene. The composite material can include aluminum (e.g., 90 wt % Al to 99.9 wt % Al) and 0.1 wt % to 10 wt % MXene. The composite material can include 97 wt % Al to 99.9 wt % Al and 0.1 wt % to 3 wt % MXene. The composite material can include copper (e.g., 90 wt % Cu to 99.9 wt % Cu) and 0.1 wt % to 10 wt % MXene. The composite material can include 97 wt % Cu to 99.9 wt % Cu and 0.1 wt % to 3 wt % MXene.

In embodiments in which the composite material includes aluminum, the electrical conductivity of the composite material can be greater than an electrical conductivity of pure aluminum. The corrosion resistance of the composite material can be greater than the corrosion resistance of pure aluminum. The mechanical strength of the composite material can be greater than the mechanical strength of pure aluminum.

In embodiments in which the composite material includes an aluminum alloy (e.g., AL 1100), the electrical conductivity of the composite material can be greater than an electrical conductivity of the aluminum alloy. The corrosion resistance of the composite material can be greater than the corrosion resistance of the aluminum alloy. The mechanical strength of the composite material can be greater than the mechanical strength of the aluminum alloy.

In embodiments in which the composite material includes copper, the electrical conductivity of the composite material can be greater than an electrical conductivity of pure copper. The corrosion resistance of the composite material can be greater than the corrosion resistance of pure copper. The mechanical strength of the composite material can be greater than the mechanical strength of pure copper. Nanoscale copper deposition can be achieved on the MXene surface to produce copper-in-MXene composites. MXene integration into bulk copper matrices can be achieved through MXene-in-copper composites.

The composite material can be used in and for various applications. For example, the composite material can be part of an electrical wire (e.g., electrical wiring), a power transmission cable, a microelectronics device, or an aerospace device. In the example where the composite material having increased mechanical strength and electrical conductivity is used in a power transmission cable, comparatively less material would need to be used. This address the common problem of power transmission cables sagging.

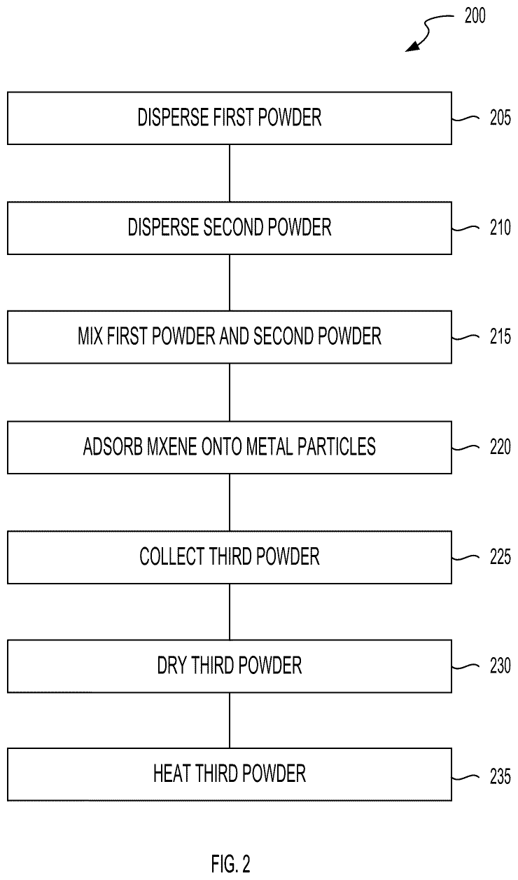

FIG. 2 illustrates a schematic flow diagram of a method 200 for forming metal-MXene composites. In brief summary, the method 200 includes dispersing a first powder (operation 205). The method 200 includes dispersing a second powder (operation 210). The method 200 includes mixing the first powder and the second powder (operation 215). The method 200 includes adsorbing MXene onto metal particles (operation 220). The method 200 includes collecting a third powder (operation 225). The method 200 includes drying the third powder (operation 230). The method 200 includes heating the third powder (operation 235). The method 200 can ensure consistence of the metal-MXene composites by avoiding agglomeration. The method 200 can address the uniformity and scalability of composite production, making it suitable for industrial use. The method 200 can include a scalable solution-based process.

The method 200 includes dispersing the first powder (operation 205). For example, the method 200 includes dispersing the first powder in a first liquid. The first powder includes MXene nanomaterials (e.g., MXene sheets). The method 200 can include dispersing the MXene nanomaterials in the first liquid. The first liquid can include water (e.g., deionized water). In one example, the method 200 includes dispersing the MXene nanomaterials in deionized water at room temperature (e.g., 100 mg of MXene in 25 mL of deionized water). The method 200 can include uniformly dispersing the MXene nanomaterials in the first liquid.

The method 200 includes dispersing the second powder (operation 210). For example, the method 200 includes dispersing the second powder in a second liquid. The second powder includes metal particles. The second liquid can be absolute ethanol. For example, 1 g of the second powder can be dispersed in 100 ml of ethanol. The metal particles can include aluminum (Al) particles, copper (Cu) particles, silver (Ag) particles, gold (Au) particles, nickel (Ni) particles, nickel alloy particles, or tungsten (W) particles. The aluminum particles can include Al 1100particles. The composition of Al 1100 can include 99.0-99.95% aluminum, 0.05-0.20% copper, 0.95% max iron, 0.05% max manganese, 0.95% max silicon, 0.1% max zinc, and 0.15% max residuals. The metal particles can have a diameter in a range of 1 μm to 100 μm. For example, the metal particles can have a diameter in a range of 1 μm to 25 μm, 1 μm to 50 μm, 1 μm to 75 μm, 1 μm to 100 μm, 25 μm to 50 μm, 25 μm to 75 μm, 25 μm to 100 μm, 50 μm to 75 μm, 50 μm to 100 μm, or 75 μm to 100 μm. The method 200 can include dispersing the metal particles in the second liquid. The second liquid can include ethanol. In one example, the method 200 includes dispersing the metal particles in ethanol. The method 200 can include uniformly dispersing the metal particles in the second liquid. In some embodiments, the second liquid can include at least one of HCl, HNO₃, H₂O₂, or ammonia persulfate.

The method 200 includes mixing the first powder and the second powder (operation 215). For example, the method 200 includes mixing the first powder dispersed in the first liquid with the second powder disposed in the second liquid. In some embodiments, mixing the first powder dispersed in the first liquid with the second powder dispersed in the second liquid occurs at room temperature. The first powder dispersed in the first liquid can be mixed with the second powder dispersed in the second liquid to form a mixture. The mixture can be stirred for a period of time (e.g., 1 hour).

In some embodiments, the method 200 can include increasing the zeta-potential of the metal particles. The zeta-potential of the metal particles can be increased to improve the corrosion kinetics at the interface between the metal particles and the MXenes. In some embodiments, the zeta-potential of the metal particles can be increased from a value less than or equal to 0 to a value that is greater than 0.

In some embodiments, metal-MXene composites that include Al can be formed by reacting Al with HCl. Metal-MXene composites that include Mg can be formed by reacting Mg with HCl. Metal-MXene composites that include Mn can be formed by reacting Mn with HCl. Metal-MXene composites that include Fe can be formed by reacting Fe with HCl. Metal-MXene composites that include Ni can be formed by reacting Ni with HCl. Metal-MXene composites that include Sn can be formed by reacting Sn with HCl.

In some embodiments, the metal particles can be oxidized prior to mixing the first powder and the second powder. The method 200 can include reacting the metal particles with at least one of HCl, HNO₃, H₂O₂, or (NH₄)₂S₂O₈ (ammonia persulfate). For example, the metal particles can be oxidized by HCl, HNO₃, H₂O₂, or ammonia persulfate. Metals with a lower reactivity (e.g., Cu) compared to metals with a higher reactivity (e.g., Al) can be oxidized by an oxidizer (e.g., oxidizing agent, oxidant). For example, metal-MXene composites that include Cu can be formed by oxidizing Cu with HNO₃, H₂O₂, or ammonia persulfate.

The method 200 includes adsorbing MXene onto metal particles (operation 220). For example, the method 200 includes electrostatically adsorbing the MXene nanomaterials onto the metal particles. The electrostatic adsorption of MXenes onto the metal particles can result in the self-assembly of metal-MXene composites. During the mixing of the first powder dispersed in the first liquid and the second powder dispersed in the second liquid, the MXene nanomaterials can be adsorbed onto the metal particles. The process of mixing the mixture can adsorb the MXene nanomaterials onto the metal particles. The metal particles can be coated with the MXene nanomaterials after the MXene nanomaterials adsorb onto the metal particles. The metal particles having adsorbed MXene nanomaterials can be coated metal particles. The coated metal particles can be collected.

The method 200 includes collecting the third powder (operation 225). The third powder includes MXene nanomaterials adsorbed onto the metal particles. In some embodiments, the method 200 can include separating the MXene nanomaterials adsorbed onto the metal particles from a mixture of the first liquid and the second liquid. For example, separating the MXene nanomaterials adsorbed onto the metal particles from a mixture of the first liquid and the second liquid can be performed to collect the third powder. The mixture of first liquid and the second liquid including the MXene nanomaterials adsorbed onto the metal nanoparticles can be centrifuged and/or decanted to collect the solid sample (e.g., third powder).

The method 200 includes drying the third powder (operation 230). For example, the third powder can be dried in a vacuum oven. The third powder can be dried for a time period greater than or equal to 8 hours. The third powder can be dried to remove moisture (e.g., excess moisture) from the third powder. The third powder can be dried and heated to remove moisture from the third powder. After the third powder is dried, they can be free-flowing powders. The third powder can then be formed into green bodies for further processing (e.g., melting, sintering).

The method 200 includes heating the third powder (operation 235). For example, the method 200 includes heating the third powder to form the metal-MXene composite. Heating the third powder can include sintering (e.g., spark plasma sintering) or melting. In some embodiments, heating the third powder can include sintering the third powder at a temperature in a range of 500 °C to 700 °C for a period of time in a range of 1 hour to 4 hours. For example, the third powder can be sintered at 600 °C for two hours. The method 200 can include heating the third powder at a temperature in a range of 500 °C to 550 °C, 500 °C to 600 °C, 500 °C to 650 °C, 500 °C to 700 °C, 550 °C to 600 °C, 550 °C to 650 °C, 550 °C to 700 °C, 600 °C to 650 °C, 600 °C to 700 °C, or 650 °C to 700 °C. In some embodiments, heating the third powder can include melting the third powder to form a liquid.

The metal-MXene composite can include 0.1 wt % to 10 wt % MXene (e.g., MXene nanomaterials). For example, the metal-MXene composite can include 0.1 wt % to 1 wt % MXene, 0.1 wt % to 2 wt % MXene, 0.1 wt % to 3 wt % MXene, 0.1 wt % to 4 wt % MXene, 0.1 wt % to 5 wt % MXene, 0.1 wt % to 6 wt % MXene, 0.1 wt % to 7 wt % MXene, 0.1 wt % to 8 wt % MXene, 0.1 wt % to 9 wt % MXene, 0.1 wt % to 10 wt % MXene, 1 wt % to 2 wt % MXene, 1 wt % to 3 wt % MXene, 1 wt % to 4 wt % MXene, 1 wt % to 5 wt % MXene, 1 wt % to 6 wt % MXene, 1 wt % to 7 wt % MXene, 1 wt % to 8 wt % MXene, 1 wt % to 9 wt % MXene, 1 wt % to 10 wt % MXene, 2 wt % to 3 wt % MXene, 2 wt % to 4 wt % MXene, 2 wt % to 5 wt % MXene, 2 wt % to 6 wt % MXene, 2 wt % to 7 wt % MXene, 2 wt % to 8 wt % MXene, 2 wt % to 9 wt % MXene, 2 wt % to 10 wt % MXene, 3 wt % to 4 wt % MXene, 3 wt % to 5 wt % MXene, 3 wt % to 6 wt % MXene, 3 wt % to 7 wt % MXene, 3 wt % to 8 wt % MXene, 3 wt % to 9 wt % MXene, 3 wt % to 10 wt % MXene, 4 wt % to 5 wt % MXene, 4 wt % to 6 wt % MXene, 4 wt % to 7 wt % MXene, 4 wt % to 8 wt % MXene, 4 wt % to 9 wt % MXene, 4 wt % to 10 wt % MXene, 5 wt % to 6 wt % MXene, 5 wt % to 7 wt % MXene, 5 wt % to 8 wt % MXene, 5 wt % to 9 wt % MXene, 5 wt % to 10 wt % MXene, 6 wt % to 7 wt % MXene, 6 wt % to 8 wt % MXene, 6 wt % to 9 wt % MXene, 6 wt % to 10 wt % MXene, 7 wt % to 8 wt % MXene, 7 wt % to 9 wt % MXene, 7 wt % to 10 wt % MXene, 8 wt % to 9 wt % MXene, 8 wt % to 10 wt % MXene, or 9 wt % to 10 wt % MXene. The amount of MXene in the metal-MXene composite can be such as to enhance certain properties of the composite compared with the baseline (e.g., bare) metal. In some embodiments, the metal-MXene composite can have less than 0.1 wt % MXene. In some embodiments, the metal MXene composite can have greater than 10 wt % MXene.

The metal-MXene composite can include metal and MXene. For example, the metal-MXene composite includes a metal (e.g., 90 wt % metal to 99.9 wt % metal) and 0.1 wt % to 10 wt % MXene. The metal-MXene composite can include aluminum (e.g., 90 wt % Al to 99.9 wt % Al) and 0.1 wt % to 10 wt % MXene. The metal-MXene composite can include copper (e.g., 90 wt % Cu to 99.9 wt % Cu) and 0.1 wt % to 10 wt % MXene. The MXene can be uniformly or non-uniformly distributed in the metal-MXene composite. The metal can be uniformly or non-uniformly distributed in the metal-MXene composite.

In some embodiments, an electrical conductivity of the third powder is greater than an electrical conductivity of the second powder. The electrical conductivity of the metal-MXene composite can be greater than an electrical conductivity of the second powder. In another example, the electrical conductivity of the third powder after heating (e.g., after being heated) is greater than the electrical conductivity of the third powder prior to heating. For example, the electrical conductivity of the metal-MXene composite can be greater than the electrical conductivity of the third powder prior to heating. Heating the third powder can enhance the electrical conductivity of the third powder. In yet another example, the electrical conductivity of the third powder after sintering (e.g., after being sintered) is greater than the electrical conductivity of the third powder prior to sintering. For example, the electrical conductivity of the metal-MXene composite can be greater than the electrical conductivity of the third powder prior to sintering. Sintering the third powder can enhance the electrical conductivity of the third powder.

In some embodiments, a corrosion resistance of the metal-MXene composite is greater than a corrosion resistance of the second powder. For example, the corrosion resistance of the third powder can be greater than the corrosion resistance of the second powder. In another example, the corrosion resistance of the third powder after heating is greater than the corrosion resistance of the third powder prior to heating.

In some embodiments, a mechanical strength of the metal-MXene composite is greater than a mechanical strength of the second powder. For example, the mechanical strength of the third powder can be greater than the mechanical strength of the second powder. In another example, the mechanical strength of the third powder after heating is greater than the mechanical strength of the third powder prior to heating.

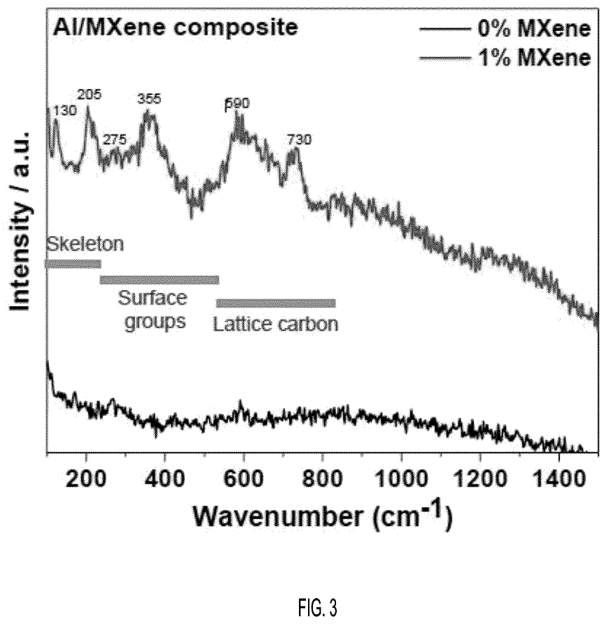

FIG. 3 illustrates a plot of intensity (a.u.) vs. wavenumber (cm⁻¹). The plot shows the intensity of a sample having 0 wt % MXene and an Al/MXene composite having 1 wt % MXene as measured using Raman spectroscopy. The sample having 0% MXene does not have any significant peaks. The Al/MXene composite having 1% MXene has peaks corresponding to MXene. The peaks corresponding to MXene include peaks indicating the skeleton, surface groups, and lattice carbon. The sample having 0 wt % MXene and the Al/MXene composite having 1 wt % MXene can be characterized by Raman spectroscopy.

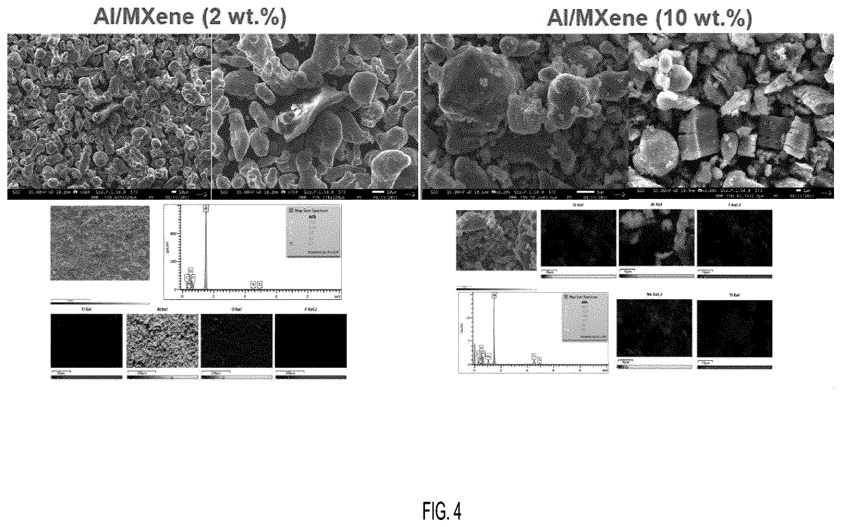

FIG. 4 illustrates the SEM/EDS analysis of metal-MXene composites. On the top left are scanning electron microscopy (SEM) images of an Al/MXene composite having 2 wt % MXene. On the bottom left are the energy-dispersive X-ray spectroscopy (EDS) results of the Al/MXene composite having 2 wt % MXene. On the top right are SEM images of an Al/MXene composite having 10 wt % MXene. On the bottom right are the EDS results of the Al/MXene composite having 10 wt % MXene. MXenes are easily visible in the Al/MXene composite having 10 wt % MXene. The Al/MXene composite having 2 wt % MXene and the Al/MXene composite having 10 wt % MXene can be characterized by SEM and EDS.

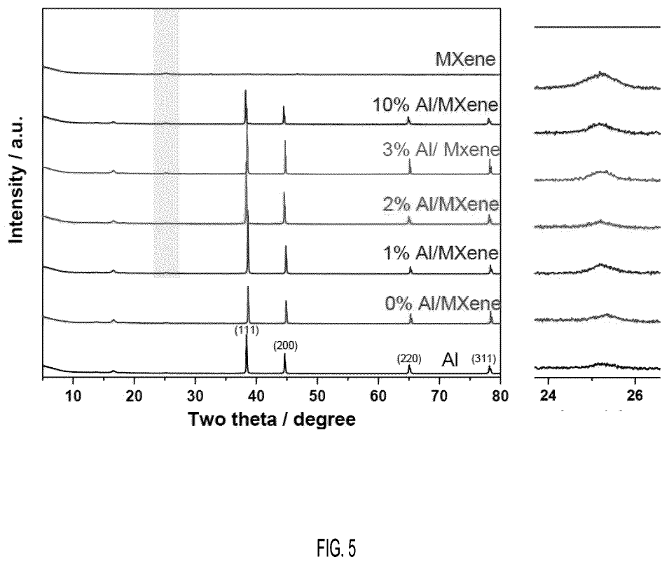

FIG. 5 illustrates the XRD analysis of various samples. The samples include MXene, an Al/MXene composite having 10 wt % MXene, an Al/MXene composite having 3 wt % MXene, an Al/MXene composite having 2 wt % MXene, an Al/MXene composite having 1 wt % MXene, an Al/MXene composite having 0 wt % MXene, and Al 1100. The Al 1100 sample is a raw, untreated sample, while the Al/MXene composite having 0 wt % MXene is an Al sample that has undergone a liquid or solution treatment (e.g., mixing the first liquid with the second liquid). The Al 1100 sample is highly crystalline. For the Al/MXene samples, the MXene peaks are not as prominent due to the highly crystalline nature of Al. The MXene peaks are visible above a loading of 2 wt %. The samples can be characterized by x-ray diffraction (XRD).

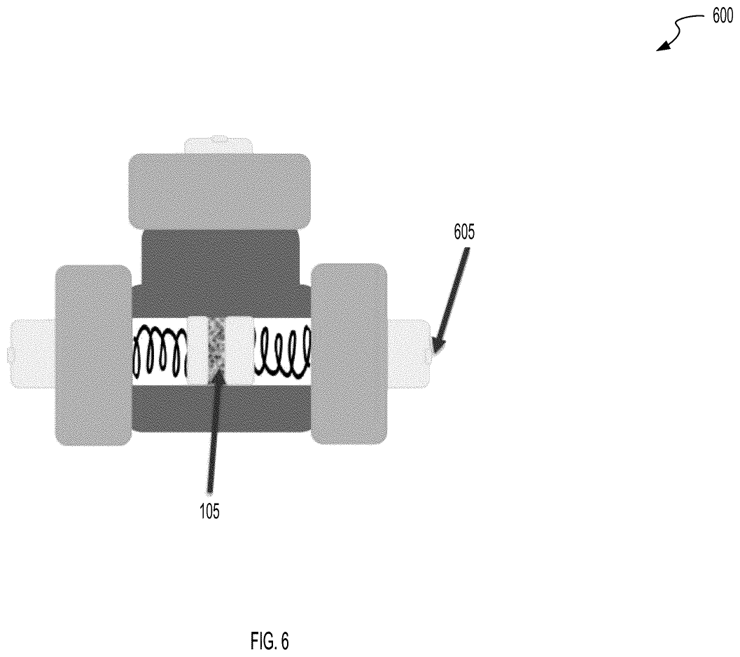

FIG. 6 illustrates a diagram of a T-cell 600. The T-cell 600 can receive a metal-MXene composite 105. The metal-MXene composite 105 can be in the form of a pellet. For example, the metal-MXene composite 105 can include an Al/MXene pellet. The metal-MXene composite 105 can be pressed into a pellet. The T-cell can include one or more connection ports 605. The T-cell 600 can be used to determine the conductivity (e.g., electronic conductivity) of the metal-MXene composite 105.

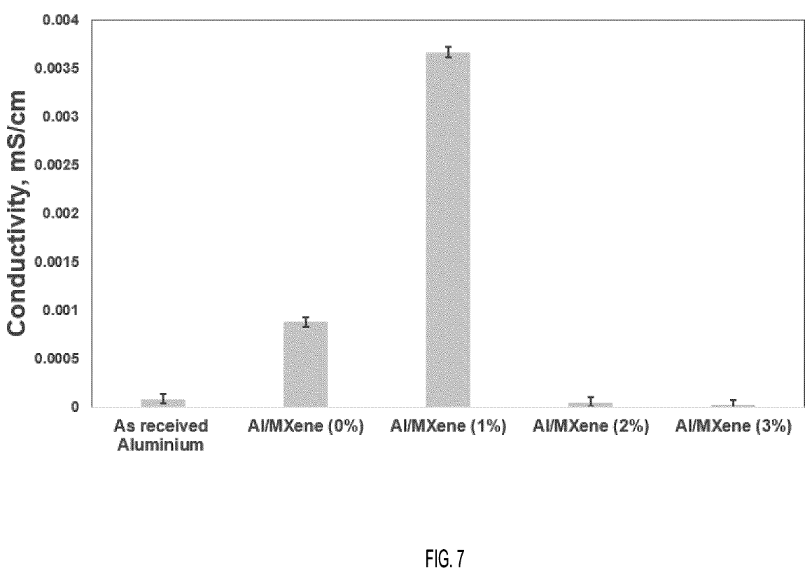

FIG. 7 illustrates a plot of electronic conductivities of various samples before sintering. The samples include as-received aluminum, an Al/MXene composite having 0 wt % MXene, an Al/MXene composite having 1 wt % MXene, Al/MXene composite having 2 wt % MXene, and Al/MXene composite having 3 wt % MXene. The conductivity of the as-received aluminum is less than 0.005 mS/cm. The conductivity of the Al/MXene composite having 0 wt % MXene is between 0.001 mS/cm and 0.005 mS/cm. The conductivity of the Al/MXene composite having 1 wt % MXene is between 0.0035 mS/cm and 0.0040 mS/cm. The conductivity of the Al/MXene composite having 2 wt % MXene is less than 0.005 mS/cm. The conductivity of the Al/MXene composite having 3 wt % MXene is less than 0.005 mS/cm. The results show the effect of the MXene in improving electronic conductivity of the composite material. Before the composite samples are sintered, the introduction of MXenes to the material can improve the conductivity compared to the baseline metal by tailoring the grain boundaries and removing surface oxidation.

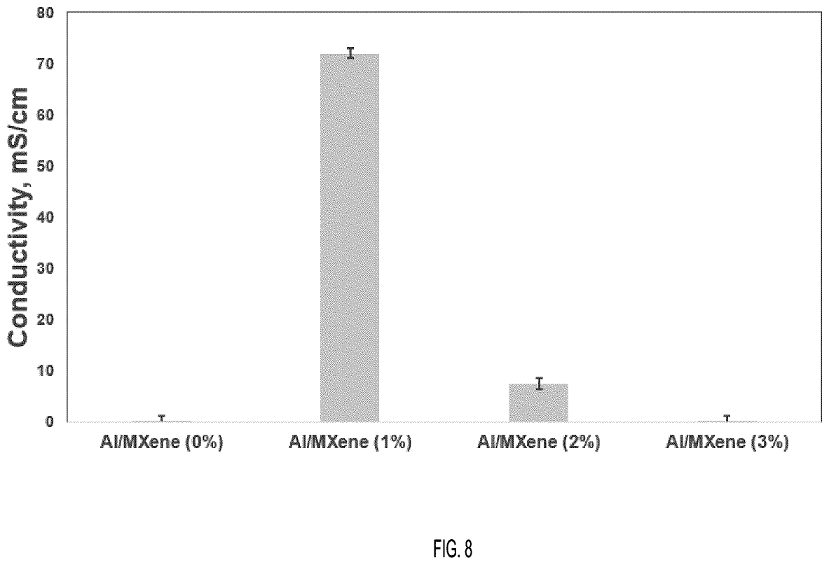

FIG. 8 illustrates a plot of electronic conductivities of various samples after sintering. The samples include as-received aluminum, an Al/MXene composite having 0 wt % MXene, an Al/MXene composite having 1 wt % MXene, Al/MXene composite having 2 wt % MXene, and Al/MXene composite having 3 wt % MXene. The samples were sintered at 600 °C for 2 hours. The conductivity of the Al/MXene composite having 0 wt % MXene (e.g., pure Al) after sintering is less than 1 mS/cm. The conductivity of the Al/MXene composite having 1 wt % MXene after sintering is between 70 mS/cm and 80 mS/cm. The conductivity of the Al/MXene composite having 2 wt % MXene after sintering is between 5 mS/cm and 10 mS/cm. The conductivity of the Al/MXene composite having 3 wt % MXene is less than 1 mS/cm. The results show the effect of sintering in improving electronic conductivity.

The synthesis of MXenes can be in aqueous-based acids and/or chemical intercalants, which can add hydrophilic groups such as —(OH) and —O. As a result of the synthesis process, MXenes can be stable in water. A self-assembly approach of single-flake MXene to the metal particles can be accomplished by ensuring that the metal particles have a positive surface charge equal to or greater than the MXene in water. The self-assembly approach can be scalable such that it produces metal-MXene composites on the order of tens of grams or more. The self-assembly can be controlled by modifying the surface charge (e.g., zeta-potential, ζ-potential) of the metal in various solvents. The self-assembly of MXenes onto the surface of the metal particles can occur with ζ-potentials of the metal greater than 0 and/or more readily with higher ζ-potentials of the metal.

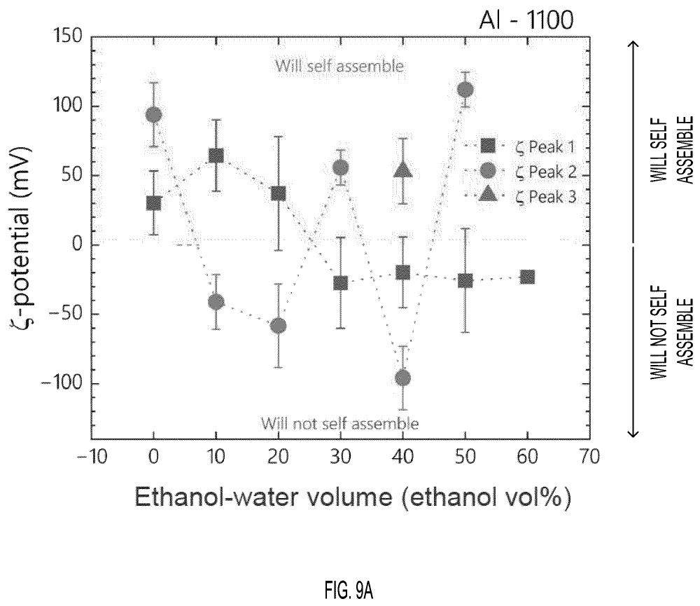

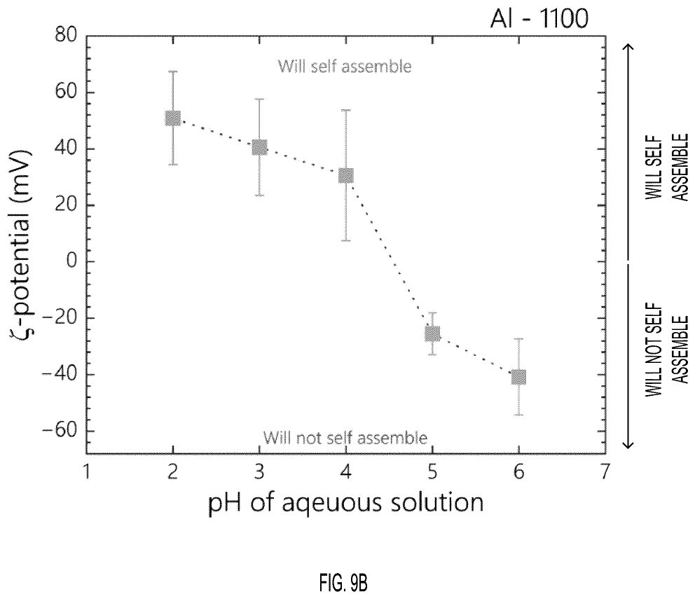

FIG. 9A illustrates a plot of ζ-potential vs. ethanol-water volume for Al 1100. FIG. 9B illustrates a plot of ζ-potential vs. pH for Al 1100. These plots show the cleanest (single-peak) ζ-potential with pH modification rather than water-ethanol ζ-potential control. This illustrates that zeta-based self-assembly can be accomplished using pH modification to improve the corrosion kinetics at the solution-metal particle interface. As shown in FIG. 9B, the ζ-potential of the aluminum is greater than 0 when the pH of the solution is less than or equal to 4. The ζ-potential of the aluminum is less than 0 when the pH of the solution is greater than equal to 5.

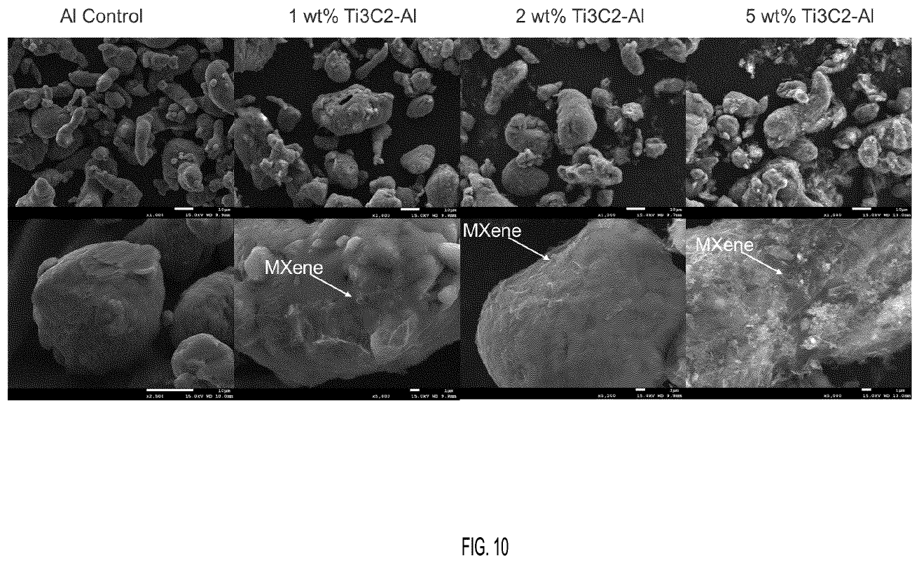

FIG. 10 illustrates SEM images of Al-MXene composites. The control Al (e.g., Al control, Al control with no MXene) shows no flake-like edges. The Al-MXene composites with 1 wt % Ti₃C₂ and 2 wt % Ti₃C₂ show conformal wrapping of Al grains. The Al-MXene composite with 5 wt % Ti₃C₂ shows multi-layer stacking of MXenes on top of Al grains.

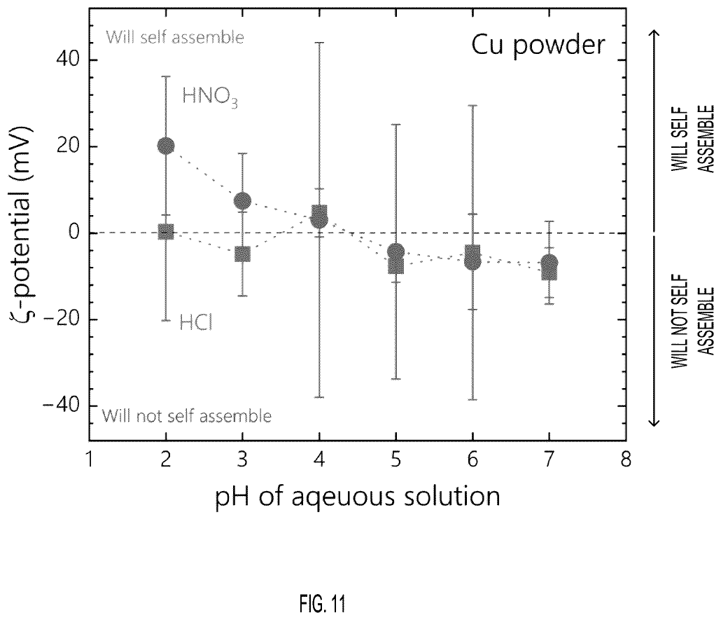

FIG. 11 illustrates a plot of ζ-potential vs. pH for Cu. The ζ-potential for Cu mixed with HNO₃ was greater than the ζ-potential for Cu mixed with HCl. This plot illustrates that mixing HCl and Cu does not or does not significantly increase the ζ-potential of Cu above 0. As shown in FIG. 11, the ζ-potential of the copper is greater than 0 when the pH of the solution including HNO₃ is less than or equal to 4. The ζ-potential of the copper is less than 0 when the pH of the solution including HNO₃ is greater than equal to 5.

The reactivity of Cu is less than the reactivity of other metals such as Mg, Al, Mn, Fe, Ni, and Sn. Cu may need to be oxidized by a reactant to transform Cu⁰ to Cu²⁺ in solution so that self-assembly of Cu and MXenes can occur. A Cu oxidizer such as HNO₃, H₂O₂, or ammonia persulfate can be used to increase the ζ-potential of Cu. Prior to, subsequent to, or as an alternative to dispersing the Cu particles in the second liquid, the Cu particles can be oxidized to increase the ζ-potential of Cu and promote self-assembly of Cu and MXenes.

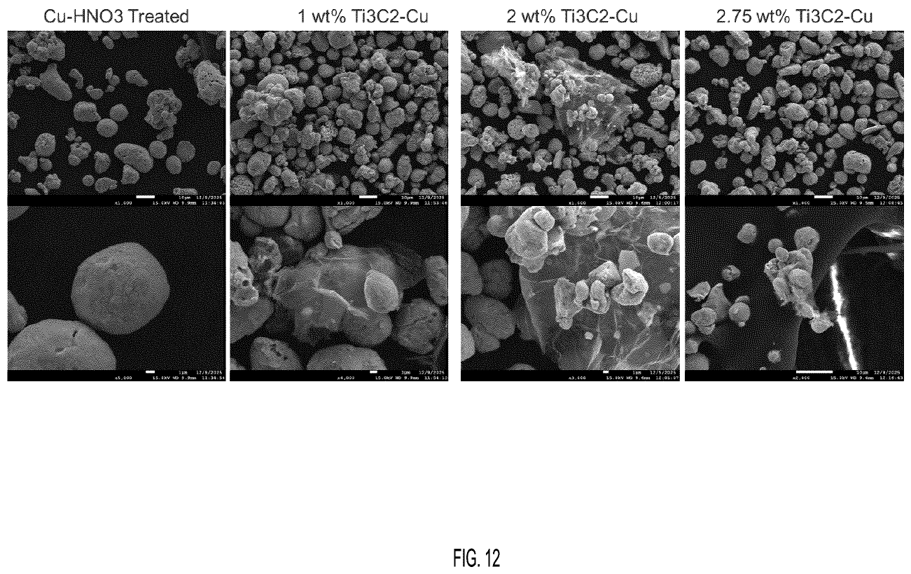

FIG. 12 illustrates SEM images of Cu-MXene composites. The control Cu (e.g., Cu—HNO₃ treated, Cu control with no MXene) shows no flake-like features. The Cu-MXene composites with greater than 1 wt % Ti₃C₂ (e.g., 2 wt % Ti₃C₂, 2.75 wt % Ti₃C₂) show the presence of single-to few flake MXene with Cu.

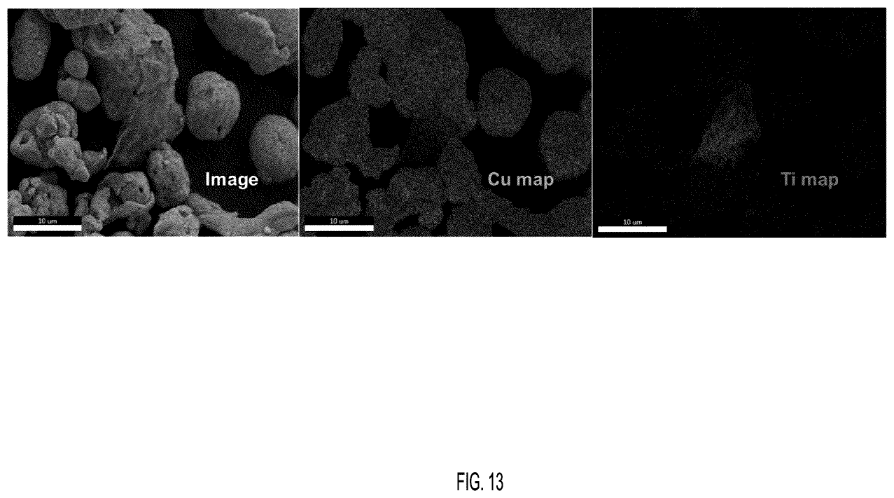

FIG. 13 illustrates an EDS analysis of Cu-MXene composites. The EDS results (e.g., Cu map and Ti map) show that Ti and Cu are separated.

No claim element herein is to be construed under the provisions of 35 U.S.C. § 112(f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method, comprising:
dispersing a first powder comprising MXene nanomaterials in a first liquid;
dispersing a second powder comprising metal particles in a second liquid;
mixing the first powder dispersed in the first liquid with the second powder dispersed in the second liquid;
electrostatically adsorbing the MXene nanomaterials onto the metal particles;
collecting a third powder comprising the MXene nanomaterials adsorbed onto the metal particles;
drying the third powder; and
heating the third powder to form a metal-MXene composite.

2. The method of claim 1, wherein an electrical conductivity of the third powder is greater than an electrical conductivity of the second powder.

3. The method of claim 1, wherein an electrical conductivity of the third powder after heating is greater than an electrical conductivity of the third powder prior to heating.

4. The method of claim 1, wherein heating the third powder comprises at least one of sintering or melting.

5. The method of claim 1, comprising:
separating the MXene nanomaterials adsorbed onto the metal particles from a mixture of the first liquid and the second liquid.

6. The method of claim 1, wherein the metal-MXene composite comprises:
0.1 wt % to 10 wt % MXene.

7. The method of claim 1, wherein the metal-MXene composite comprises:
0.1 wt % to 3 wt % MXene.

8. The method of claim 1, wherein the metal particles comprise at least one of aluminum particles, copper particles, silver particles, gold particles, nickel particles, or tungsten particles.

9. The method of claim 1, wherein the metal-MXene composite comprises:
aluminum; and
0.1 wt % to 10 wt % MXene.

10. The method of claim 1, wherein heating the third powder comprises sintering the third powder at a temperature in a range of 500 °C to 700 °C for a period of time in a range of 1 hour to 4 hours.

11. The method of claim 1, wherein the metal particles have a diameter in a range of 1 μm to 100 μm.

12. The method of claim 1, wherein mixing the first powder dispersed in the first liquid with the second powder dispersed in the second liquid occurs at room temperature.

13. The method of claim 1, wherein a corrosion resistance of the metal-MXene composite is greater than a corrosion resistance of the second powder.

14. The method of claim 1, wherein a mechanical strength of the metal-MXene composite is greater than a mechanical strength of the second powder.

15. The method of claim 1, comprising:
increasing a zeta-potential of the metal particles.

16. The method of claim 1, comprising:
reacting the metal particles with at least one of HCl, HNO₃, H₂O₂, or (NH₄)₂S₂O₈.

17. A composite material, comprising:
aluminum; and
0.1 wt % to 10 wt % MXene.

18. The composite material of claim 17, comprising:
0.1 wt % to 3 wt % MXene.

19. The composite material of claim 17, wherein an electrical conductivity of the composite material is greater than an electrical conductivity of pure aluminum.

20. A device comprising the composite material of claim 17, wherein the device is at least one of an electrical wire, a power transmission cable, a microelectronics device, or an aerospace device.
